(19) United States
(12) Patent Application Publication
(10) Pub. No.: US 2016/0134020 A1
(43) Pub. Date: May 12, 2016

(54) MAGNETIC SHIELDING FOR AN ANTENNA, USING A COMPOSITE BASED ON THIN MAGNETIC LAYERS, AND ANTENNA COMPRISING SUCH A SHIELDING

(71) Applicant: COMMISSARIAT À L'ÉNERGIE ATOMIQUE ET AUX ÉNERGIES ALTERNATIVES, Paris (FR)

(72) Inventors: Anne Lise ADENOT ENGELVIN, Luynes (FR); Sebastien DUBOURG, Esvres (FR)

(73) Assignee: Commissariat a l'energie atomique et aux energies alternatives, Paris (FR)

(21) Appl. No.: 14/896,841

(22) PCT Filed: Jun. 12, 2014
(86) PCT No.: PCT/EP2014/062250

§ 371 Date: Dec. 8, 2015

(30) Foreign Application Priority Data
Jun. 14, 2013 (FR) 13 55562

(51) Int. Cl. H01Q 7/06; H01Q 1/52

(52) U.S. Cl. CPC H01Q 7/06; H01Q 1/526

(57) ABSTRACT

A magnetic shielding for an antenna using a composite based on thin magnetic layers, including plural films each including a thin magnetic layer of a thickness between 1 and 10 μm deposited on a flexible electrically insulating substrate of a thickness between 1 and 100 μm. The films are assembled into a multilayer assembly to form a sheet of a thickness between 10 and 1,000 μm.

### TECHNICAL FIELD

The invention relates to a magnetic shielding for an antenna using a composite based on thin magnetic layers and an antenna comprising such a shielding, for example in the field of RFID (“Radio Frequency Identification” or “radio-identification”) applications.

In the rest of the description, the field of RFID applications will be considered by way of example.

### STATE OF PRIOR ART

The magnetic shielding for an antenna raises a significant problem to be solved, which is to ensure the performance of the transmitting and receiving antenna when the antenna is placed near a solid conducting material. The typical example of an antenna requiring a magnetic shielding is the field of RFID applications, the system comprising a tag and a reader. The tag is comprised of an RFID antenna and a chip in which are stored information to be read thanks to the reader which queries the antenna. When, as illustrated in FIG. 1, this antenna 10 is placed in proximity to a solid conducting material such as the metal plan 11, for example the floorplan of an electric board, a battery case . . . , the former, due to its conducting feature and its thickness, is the location of induced currents which disrupt the signal transmitted or received by the antenna. It is necessary to make a purely magnetic shielding 12 for the antenna, which will guide the field lines so as to mask the metal plan for the antenna to keep a good signal to noise ratio. The material used must exhibit a strong real permeability and a minimum weight so as not to weigh down the device, namely a maximum ratio μ′/d, μ′ being the real permeability and d the material density. Magnetic losses which lead to an absorption must be limited and are expressed through the imaginary permeability μ″. The ratio Q=μ′/μ″ (f), referred to as quality factor, must be maximum at the operating frequency of the antenna.

Present materials have the following performances and drawbacks.

Sintered ferrites are traditionally good materials for a magnetic shielding. They have high levels of permeability and a good quality factor. However, they are too rigid for applications of flexible labelling, for example for identifying a bottle of wine, . . . and too heavy for mobile telephony type applications.

Mumetal-type rolled sheets are commonly used for making a magnetic shielding at very low frequencies, for example in the order of 100 kHz. At the radiofrequencies in the order of 10 MHz, the minimum thicknesses accessible by the method for producing these sheets are too significant and provide them a solid conducting feature similar to the one of the floorplan.

New materials are therefore necessary for this application. Magnetic composites based on powders and fillers of various forms, for example slices, fibres, . . .

dispersed in an electrically conducting matrix made of polymers, elastomers, . . . have low levels of magnetic permeability, typically μ′ between 10 and 20. Better magnetic performances, up to μ′=50, can be reached by increasing the powder volume fraction, but this reduces the flexibility of the material and increases its reflectivity.

The object of the invention is to solve such a technical problem.

### DISCLOSURE OF THE INVENTION

The invention relates to a magnetic shielding for an antenna using a composite based on thin magnetic layers, characterized in that it comprises several films each comprised of a thin magnetic layer of a thickness between 1 and 10 μm deposited on a flexible electrically insulating substrate of a thickness between 1 and 100 μm, these films being assembled into a multilayer assembly in order to form a sheet of a thickness between 10 and 1,000 μm.

According to the antenna design, the magnetic properties of the sheet can be advantageously made isotropic by alternating the magnetization orientation of the magnetic films. Manufacturing the magnetic layer can be made by using various technologies: “Physical Vapour Deposition” (cathode sputtering, evaporation, laser ablation . . . ), “Chemical Vapour Deposition, electroplating”, sol-gel deposition, or any other type of method enabling a thin magnetic layer to be manufactured.

The flexible electrically insulating substrate can be a polymeric substrate. The magnetic films can be separated by adhesive layers. The substrate can be a self-adhesive substrate. The substrate can be a heat-sealable substrate.

In an exemplary embodiment the magnetic layers are CoZrPt ferromagnetic layers deposited on a polyethylene terephthalate flexible substrate. The magnetic films are assembled by polyester adhesive layers, or heat-sealed by hot pressing.

The invention also relates to an antenna comprising such a shielding, especially in the field of RFID applications.

The main advantages of the invention are as follows:
It enables good magnetic shielding performances at the operating frequencies of the antennas to be obtained.
It enables a good mechanical flexibility, which is required especially for a flexible labelling, to be kept.
It is based on proven manufacturing techniques (deposition of thin layers).
It is based on the use of flexible polymeric films already used in the labelling sector.

### BRIEF DESCRIPTION OF THE DRAWINGS

FIG. 1 illustrates the principle of the magnetic shielding between a transmitting/receiving antenna and a floorplan.

FIG. 2 illustrates the magnetic shielding of the invention.

FIGS. 3A and 3B illustrate the magnetic shielding of the invention, respectively with an anisotropic permeability sheet and an isotropic permeability sheet.

FIG. 4 illustrates a first alternative magnetic shielding of the invention.

FIG. 5 illustrates a second alternative magnetic shielding of the invention.

FIG. 6 illustrates the comparison of the performances of isotropic or anisotropic sheets with commercial magnetic materials for the magnetic shielding according to the invention.

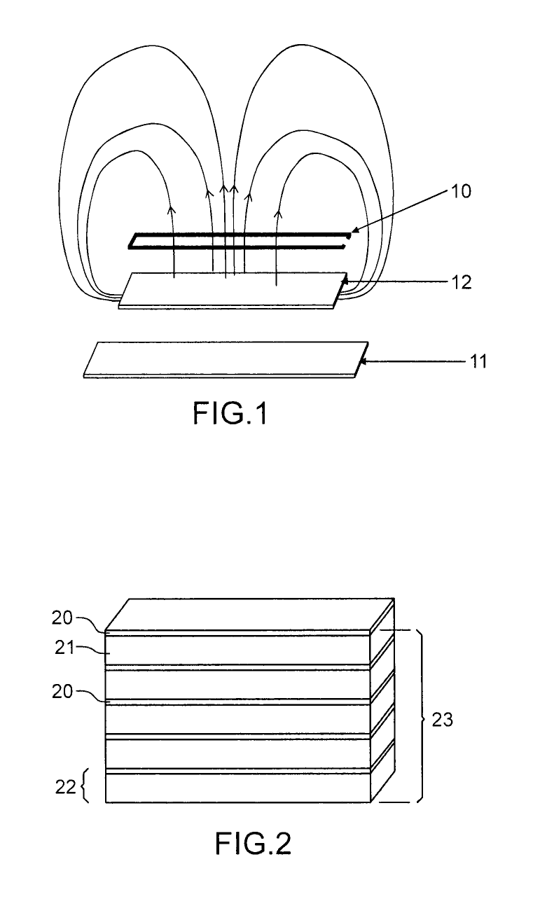

### DETAILED DISCLOSURE OF PARTICULAR EMBODIMENTS

The magnetic shielding of the invention comprises magnetic films 22 each formed of a thin magnetic layer 20 of a thickness t_{C} between 1 and 10 μm deposited on a flexible electrically insulating substrate 21 of a thickness t_{P} between 1 and 100 μm. A substrate+magnetic layer assembly is thus referred to as “magnetic film” 22. A number N (N an integer higher than 1) of films are then assembled into a multilayer assembly in order to form a sheet 23 of a thickness t_{F} between 10 and 1,000 μm, illustrated in FIG. 2. The magnetic layer has a significant real permeability, typically greater than 500, at the operating frequency, for example of 13.56 MHz. The permeability of the sheet μ_{F} is expressed as a function of the permeability of the magnetic layer μ_{M} according to the formula:

μ_{F}=1+(μ_{M}−1)*N*t_{C}/t_{F}

The sheet has a quality factor Q=μ′_{F}/μ″_{F} greater than 30. The volume fraction, which is the ratio of the magnetic material volume to the sheet volume, is greater than 8%. The permeability level of the sheet is thus greater than 40.

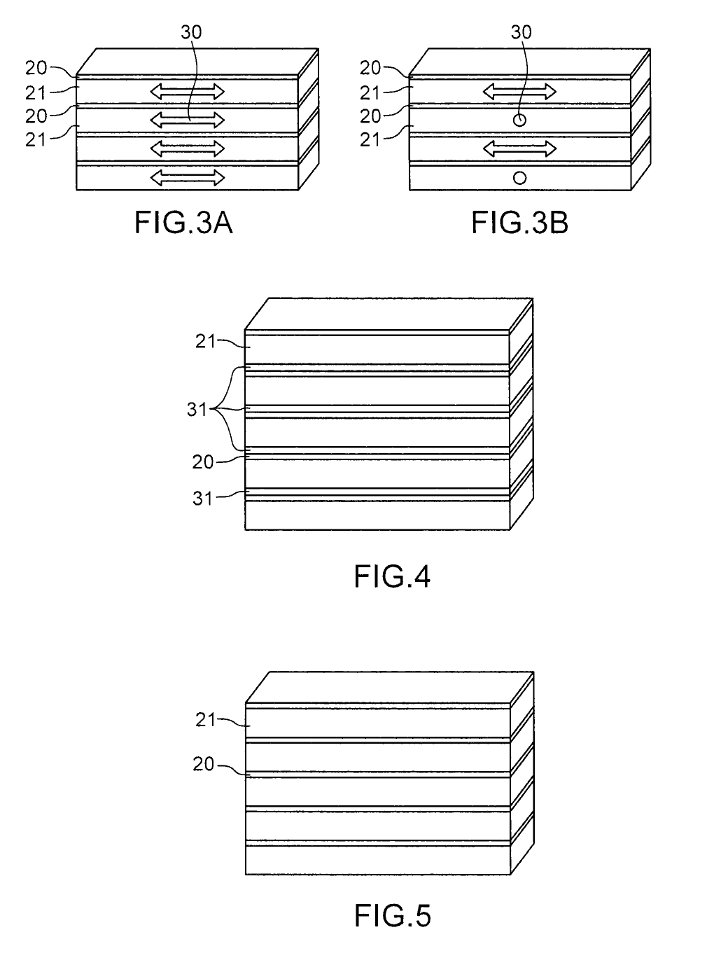

Alternating magnetic and insulating materials enables the reflectivity level of the composite to be limited, which is the main drawback of the use of a μ-metal type thick monolayer. Permeability of thin magnetic layers is generally anisotropic: it is maximum in a direction of the plan of the layer and is near 1 in an orthogonal direction to the latter. The magnetization orientation 30 of the magnetic films 22 can be alternate so as to obtain an isotropic permeability sheet 23, as illustrated in FIG. 3.

Manufacturing the magnetic layer can be made by using various technologies: “Physical Vapour Deposition” (cathode sputtering, evaporation, laser ablation . . . ), “Chemical Vapour Deposition”, electroplating, sol-gel deposition, or any other type of a method enabling a thin magnetic layer to be manufactured . . . , on polymeric substrates: polyethylene terephthalate, polyester, polyethylene, polyimide . . . .

The composite flexibility depends on the magnetic deposition volume fraction, and on the intrinsic mechanical properties (Young's modulus) of the components. Materials with a low Young's modulus are favoured in order to lower the rigidity of the assembly.

Adherence of the magnetic films constituting the assembly can be made either by inserting an adhesive between each layer, or by a self-adhesive substrate, or with a heat-sealable substrate.

This type of composite has already been provided in different geometries for arranging magnetic films, with different operations.

In the patent application FR 2698479, a composite made from magnetic films is used for microwave applications (100 MHz-10 GHz). The absorbing properties claimed in this application, related to a strong imaginary permeability and to a low real permeability, are not adapted to the magnetic shielding of the invention, for which a low imaginary permeability and a strong real permeability are necessary.

In the patent application WO 01/47064, it is provided an antenna operating with an anisotropic composite made from magnetic films. This antenna is a telecommunication antenna, designed with a floorplan and a radiative element. It operates at higher frequencies than 100 MHz, greater than those for which the magnetic shielding is operational, in which the high impedance of the composite is used as a substrate, placed on the floorplan. The magnetic films constituting it are then perpendicular to the floorplan, whereas in the invention, the magnetic films are in proximity to the radiative element in order to guide these field lines, the possible presence of a floorplan in proximity to the antenna being a drawback which can be solved by the invention.

In a first alternative device of the invention, illustrated in FIG. 4, an 1.6 μm thick CoZrPt thin ferromagnetic layer is used, it is deposited on a 6 μm thick polyethylene terephthalate flexible substrate forming a magnetic film. The real permeability of the ferromagnetic layer at 10 MHz is 570. The imaginary permeability is 10. The assembly is made with a 2 μm thick polyester adhesive layer 31. The sheet is comprised of 10 magnetic films. It has a quality factor of 57 associated with a real permeability of 98 in its anisotropic version and a quality factor of 58 associated with a real permeability of 49 in its isotropic version.

In a second alternative device of the invention, illustrated in FIG. 5, an 1.6 μm thick CoZrPt thin ferromagnetic layer is used, is deposited on a 6 μm thick polyethylene flexible substrate forming a magnetic film. The real permeability of the ferromagnetic layer at 10 MHz is 570. The imaginary permeability is 10. The assembly is heat-sealed by hot pressing. The sheet is comprised of 10 magnetic films. It has a quality factor of 57 associated with a real permeability of 121 in its anisotropic version and a quality factor of 58 associated with a real permeability of 61 in its isotropic version.

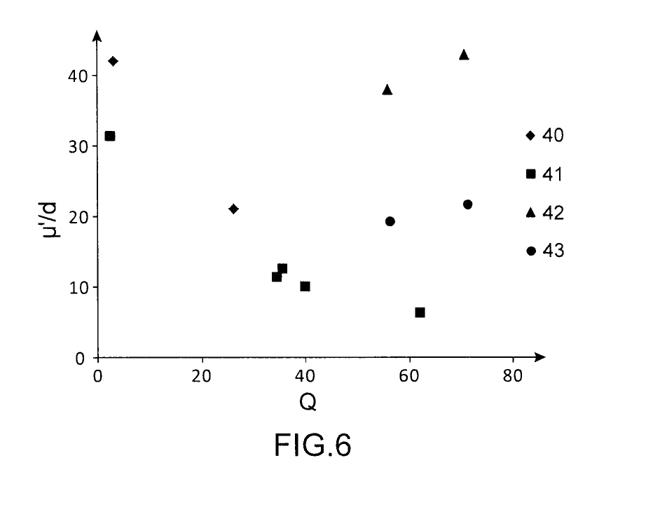

FIG. 6 illustrates the performances of these materials taking into account the quality factor Q and the ratio of the composite permeability to its density. Present commercial solutions of a magnetic shielding for RFID applications are added by way of comparison. In this figure, a commercial ferrite 40, a commercial magnetic composite 41, anisotropic sheets 42 and isotropic sheets 43 are thus represented. The isotropic or anisotropic versions of the magnetic sheets supersede the commercial solutions.

1-12. (canceled)

13: A magnetic shielding for an antenna using a composite based on thin magnetic layers, comprising:
plural films each including a thin magnetic layer of a permeability greater than 500 and of a thickness between 1 and 10 μm deposited on a flexible electrically insulating polymeric substrate of a thickness between 1 and 100 μm,
the films being assembled into a multilayer assembly, by being heat-sealed by hot pressing, to form a sheet of a thickness between 10 and 1 000 μm of a permeability greater than 40, and
wherein the magnetic depositions are performed using one of following technologies: physical vapor deposition, chemical vapor deposition, electroplating, sol-gel deposition, or any other type of method enabling a thin magnetic layer to be manufactured.

14: The magnetic shielding according to claim 13, wherein the magnetization orientation of the magnetic films is alternate.

15: The magnetic shielding according to claim 13, wherein the magnetic layers are CoZrPt ferromagnetic layers each deposited on a polyethylene terephthalate flexible substrate.

16: An antenna comprising a magnetic shielding according to claim 13.

17: The antenna according to claim 16, used in RFID applications.
